(19) United States
(12) Patent Application Publication
(10) Pub. No.: US 2022/0297389 A1
(43) Pub. Date: Sep. 22, 2022

(54) COMBINED THERMOFORMING AND ADDITIVE MANUFACTURING DEVICE

(71) Applicant: Jack Reinke, Detroit, MI (US)

(72) Inventor: Jack Reinke, Detroit, MI (US)

(21) Appl. No.: 17/694,172

(22) Filed: Mar. 14, 2022

Related U.S. Application Data
(60) Provisional application No. 63/161,897, filed on Mar. 16, 2021.

(51) Int. Cl. B29C 69/02; B29C 51/12; B29C 51/10; B29C 64/30; B29C 64/20; B33Y 10/00; B33Y 30/00; B33Y 40/20

(52) U.S. Cl. CPC B29C 69/02; B29C 51/12; B29C 51/10; B29C 64/30; B29C 64/20; B33Y 10/00; B33Y 30/00; B33Y 40/20

(57) ABSTRACT

A single-station additive manufacturing and thermoforming machine includes a heated bed forming a perforated print surface, a print head pivotable between a stowed position and a range of printing locations relative to the heated bed, and a thermoforming subassembly. The thermoforming subassembly is vertically movable relative to the heated bed to position a thermoforming sheet at a raised location to be heated to a plastic state, and a lowered position for vacuum forming over one or more printed parts upon the heated bed. The disclosure provides a fluid process between additive manufacturing and thermoforming where no interaction is needed from an operator in between additive manufacturing process stopping and thermoforming starting. The device can be easily increased in size to allow for larger parts to be manufactured and formed, while also providing a print bed that allows for air topass through for vacuum thermoforming, while also being heated.

### TECHNICAL FIELD

The present disclosure relates generally to the fields of additive manufacturing and thermoforming, and more particularly to producing a part via single-station additive manufacturing and thermoforming.

### BACKGROUND

The design and capabilities of manufacturing machines, specifically additive manufacturing or “3D printing,” are increasingly becoming a viable way to make parts for both prototypes and consumer grade products. Often the workflow for additive manufacturing includes other processes like thermoforming. In a workflow where an additive manufacturing machine and thermoform are both used there is typically a touch point or stage where the part created on the additive manufacturing device needs to be transferred to the thermoforming device, located for processing, or otherwise manipulated between stages. Such touch points add time and complexity to the overall process.

### SUMMARY

In one aspect, the present disclosure provides a combined thermoforming and additive manufacturing device in a single station dispensing with the need for outside intervention by personnel between the creation of a base portion of a part and a succeeding thermoforming process. Such a strategy offers benefits of faster prototyping and potential for enhanced automation in assembly line fashion.

According to one implementation, a machine capable of additive manufacturing and thermoforming can create parts made of various materials which can then be quickly thermoformed resulting in a negative mold or shell which can be used in various manufacturing and design applications. The device is able to complete both additive manufacturing processes and thermoforming processes without requiring movement of the part to a different station or intervention by a user, created via the additive manufacturing process, before it is thermoformed.

### BRIEF DESCRIPTION OF THE DRAWINGS

FIG. 1 is a perspective view of a manufacturing assembly from a first side;

FIG. 2 is a perspective view of the manufacturing assembly from a front side;

FIG. 3 is a perspective view of the manufacturing assembly from a top side;

FIG. 4 is a perspective view of the manufacturing assembly from a bottom side;

FIG. 5 is an isometric view of the manufacturing assembly;

FIG. 6 is an isometric view of the manufacturing assembly with detailed enlargements of two subassemblies;

FIG. 7 is a view of the manufacturing assembly at one process stage;

FIG. 8 is a view at another process stage;

FIG. 9 is a view at yet another process stage; and

FIG. 10 is a view at yet another process stage.

Corresponding reference characters are used, at least at times, to indicate corresponding parts throughout the views.

### DETAILED DESCRIPTION

The present disclosure provides the design for a combined thermoforming and additive manufacturing device in a single all-encompassing device which doesn't require outside intervention from an individual in between the creation of a part, via the additive manufacturing method, and the succeeding thermoforming of the part just created. Such a machine offers benefits of faster prototyping and potential for automation in assembly line fashion.

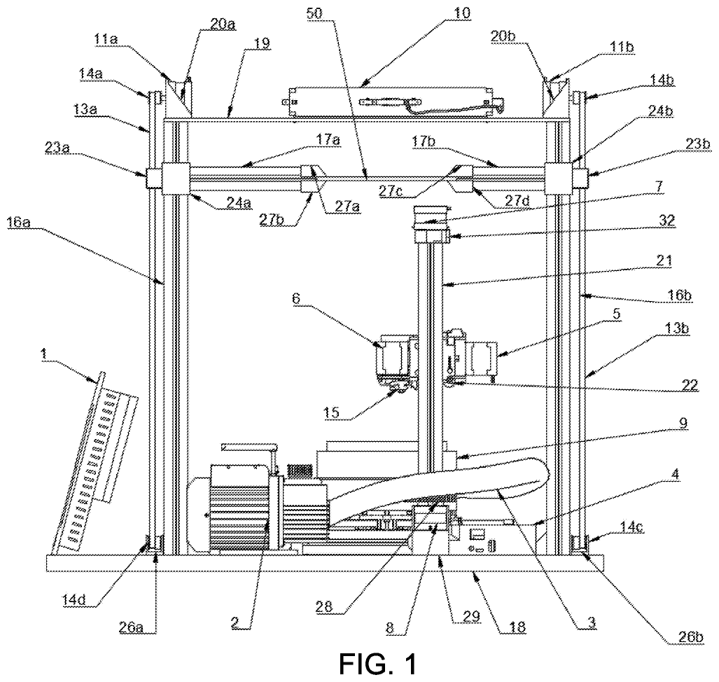

Referring to the drawings generally, but focusing first on FIG. 1, the machine 60 is shown. FIG. 1 shows the components of the machine 60 when viewed from a right side. Additionally, several components cannot be seen in FIG. 1, as they are covered by the other components. Machine 60 may include a user interface 1, thermoform structural supports 16a and 16b, trolley belt attachments 23a and 23b, trolley belts 13a and 13b, trolley steppers 11a and 11b, trolley stepper holders 20a and 20b, trolley pulleys 14a, 14b, 14c, and 14d, heating element array 10, heating element base 19, thermoplastic holder 50, thermoplastic holder clamps 27a, 27b, 27c, and 27d, vertical trolleybeams 17a and 17b, trolley slides 24a, 24b, 24c, and 24d, z-axis stepper 7, z-axis strut 21, extruder stepper 6, hot end 15, vacuum print bed 9, electronics enclosure 4, lower trolley pulley supports 26a and 26b, vacuum hose 3, base plate, 18, pivot stepper 8, pivot stepper holder 29, and driving pinion gear 28, x-axis stepper 5, vacuum 2, and z-axis stepper support 32. The terms x, y, z, and other directional indicators are used herein for purposes of convenience and do not require specific orientations in space of any given element, process, or attribute.

The additive manufacturing portion of machine 60 may include a type of fuse deposition modeling system. While this is not the only type of additive manufacturing system that could be used in machine 50, it provides a simpler method which also displays the intricacies of the machine more easily. One function in fuse deposition modeling (FDM) additive manufacturing systems is the use of a thermoplastic filament to create a part. A circular profile filament may be pushed into hot end 15 using extruder stepper 6. Usually two pinon gears, one attached to an extruder stepper, like part 6, mesh with the filament between the two gears and control the filament feed rate into the hot end.

Hot end 15 is held at a specific temperature via known electronic heating methods which liquifies and compresses the filament into a much smaller orifice that then exits the hot end, laying down a partially elastic, still hot filament which can be continuously positioned in the x and y plane to create the forms needed to manufacture a part.

Heating element array 10 is positioned above thermoplastic holder 50 and onto heating element base 19. By mounting heating element array 10 on heating element baseplate 19, a static position for heating element array 10 is provided atop of thermoform structural supports 16a, 16b, 16c, and 16d, so that when the thermoplastic holder 50 is in an upward position, the respective thermoplastic material, held by thermoplastic holder 50, can be heated to the necessary temperature to enter a plastic state.

Once the respective thermoplastic sheet held in the thermoplastic holder 50 has reached a desired plastic state via the heating element array 10, it utilizes the dynamic trolley system running the height of the machine and including trolley steppers Ila and 11b, trolley stepper holders 20a and 20b, trolley pulleys 14a, 14b, 14c, and 14d, trolley belts 13 and 13b, trolley pulley supports 26a and 26b, and linear slides 24a, 24b, 24c, and 24d. This system pairs with the actual trolley, consisting of trolley belt attachments 23a and 23b, linear slides 24a, 24b, 24c, and 24d, horizontal trolley beams 25a and 25b, vertical trolley beams 17a and 17b, thermoplastic holder clamps 27a, 27b, 27c, and 27d, and thermoplastic holder 50, which moves parallel to thermoplastic structural supports 16a, 16b, 16c, and 16d via the linear slides 24a, 24b, 24c, 24d which wrap the circumference of the thermoplastic structural supports. The driving force which dictates the position of the trolley relative the base plate are the actual trolley steppers 11a and 11b which are held in a static position by trolley stepper holders 20a and 20b. Trolley pulleys 14a and 14b are mounted on the rotor of the two steppers and have mirror trolley pulleys 14c and 14d which are driven by trolley belts 13a and 13b, and secured by trolley pulley supports 26a and 26b.

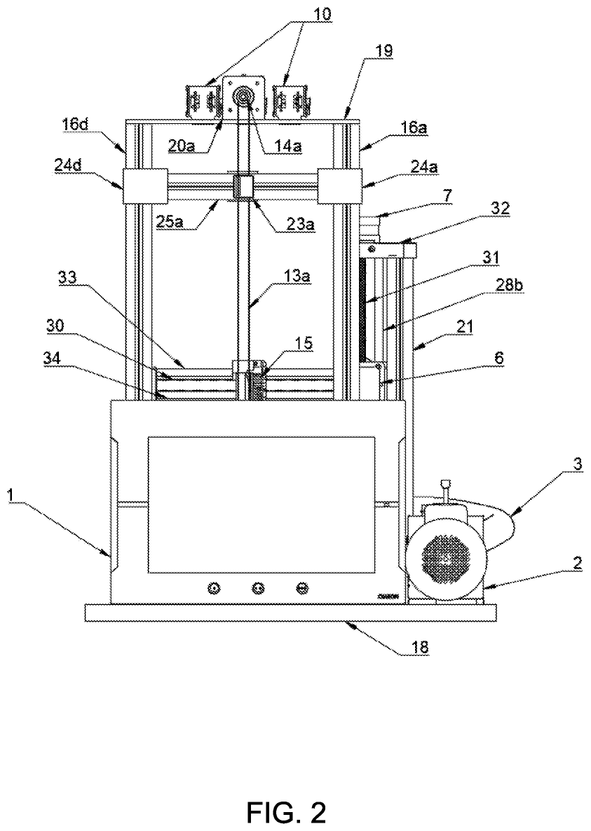

Trolley belt attachments 23a and 23b provide the mechanical engagement for the trolley system to connect with the belt system. If the system is viewed from the front, similar to FIG. 2, the trolley steppers 11a and 11b turning counter clockwise would result in the trolley sub assembly moving down, whereas a counterclockwise turn would bring the system up and closer to the heating element baseplate 19. This described movement of the trolley is responsible for moving the trolley from the position closest to the heating element array 10 down onto vacuum print bed 9, and a major function of the vacuum thermoforming aspect of the machine. It should further be appreciated that various alternatives to the presently described strategies for actuating the various parts and performing the various functions of the present disclosure might be employed. For instance, rather than a belt drive a ball screw actuator, a linear rail system including a leadscrew, a pneumatic actuator, or still others might be used. The present disclosure is applicable without regard to the specific type of actuator used to position a sheet tray, or to perform any of the other motions of the device.

As mentioned, the trolley sub assembly acts to bring the thermoplastic material down onto the additively manufactured part. However, it is common in thermoforming to include a vacuum feature as to remove the air more efficiently from the recently manufactured part so the thermoplastic material can be more tightly drawn to the part. This process is usually facilitated by a perforated surface the manufactured part sits on. The perforated surface allows for an array of inlets for the air to be sucked out to provide the improved seal around the part while thermoforming. This device includes a similar body which acts as both the additive manufacturing surface, as well as the vacuum bed 9. In another implementation, positive pressure is used to apply thermoforming material to a part. In contrast to removing air such as through perforations in a vacuum bed, in a positive pressure strategy air is forced onto a heated thermoforming sheet which is responsively urged down into contact with parts to be encased or otherwise coupled with the thermoforming sheet. The present disclosure contemplates any use of positive pressure or negative pressure to cause a thermoforming sheet to be attached to one or more parts. Applications where thermoforming is achieved without the assistance of air pressure at all are nevertheless also within the scope of the present disclosure.

Parts 27a, 27b, 27c, and 27d act as a static clamp which secures thermoplastic holder 50. Thermoplastic holder 50 needs to be able to be removed easily from machine 60 so that the respective thermoformed sheets, which have gone through the vacuum forming process, can be replaced with new ones and the machine prepared for another working cycle. The thermoplastic holder clamps act as a way to control the amount of pressure and physical engagement with thermoplastic holder 50 so this removal process can take place while maintaining enough pressure so when the trolley sub assembly is in its bottom position, thermoplastic holder 50 will not move and otherwise compromise the manufacturing process. As an alternative to mechanical clamps magnetic retention or still another mechanism, such as snap-in engagement, thumb levers, or still another strategy may be used.

FIG. 2 refers to a front view of machine 60. Similar to FIG. 1, several components cannot be seen in FIG. 2 as they are covered by other components. This view of the machine 60 displays user interface 1, vacuum 2, vacuum hose 3, extruder stepper 6, base plate 18, z-axis strut 21, z-axis linear rod 28b, lead screw 31, z-axis stepper support 32, z-axis stepper 7, linear slide 24a and 24d, thermoform structural supports 16a and 16d, heating element base 19, heating element array 10, trolley stepper holder 20a, trolley pulley 14a, x-axis linear rods 33 and 34, x-axis belt 30, horizontal trolley beam 25a, trolley belt attachment 23a, trolley belt 13a, and hot end 15.

User interface 1 is most clearly seen in this view. The user interface serves as an electronic screen that allows the user to access settings and maintenance of machine 60. A variety of programmable functions can be accessed from this component and allows users to change features to make better final results and match their use cases without having to load full new software onto the machine.

The design of this machine is such that machine 60's manufacturing build volume can be expanded without major design features. As noted, thermoform structural supports 16a, 16b, 16c, and 16d, and z-axis strut 21. These supports/struts are part of what may physically limit both the additive manufacturing build height and the respective thermoforming to go around a taller part. These parts are kept at a simple geometry so the parts could be extruded or shortened to a different length to make a different size machine to match a user's needs.

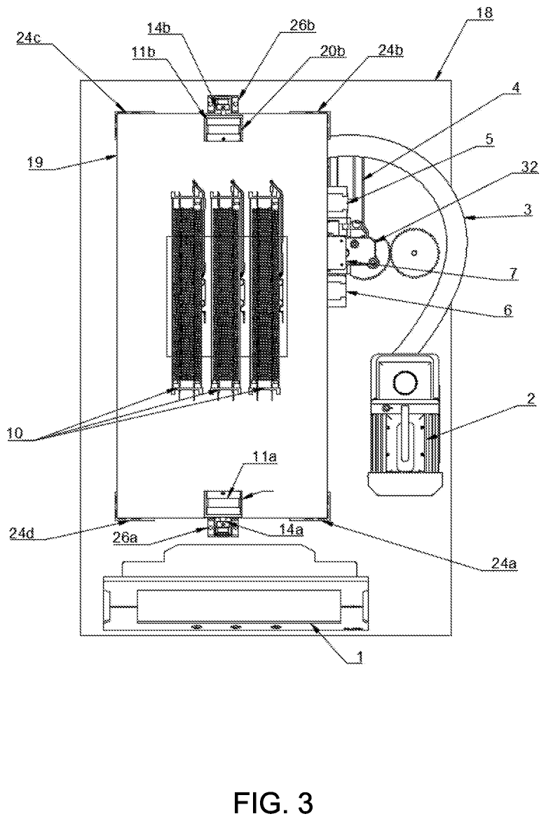

FIG. 3 refers to a top view of machine 60. Similar to FIG. 1 and FIG. 2, several components cannot be seen in FIG. 3 as they are covered by other components. This view of the machine 60 displays user interface 1, vacuum 2, vacuum hose 3, extruder stepper 6, z-axis stepper 7, x-axis stepper 5, electronics enclosure 4, base plate 18, linear slides 24a, 24b, 24c, and 24d, trolley steppers 11a and 11b, trolley stepper holders 20a and 20b, trolley pulleys 14a and 14b, trolley pulley supports 26a and 26b, heating element base 19, z-axis stepper support 32, and heating element array 10.

Heating element array 10, is most clearly seen from this view. Positioning the heating element array 10 atop of the machine allows thermoplastic holder 50 to be far above the print surface, such that the thermoplastic sheet that thermoplastic holder 50 will contain can be heated to the necessary temperature without affecting other parts that may otherwise be affected by high levels of heat like z-axis stepper 7 or vacuum 2. Once thermoplastic tray 50 and its respective thermoplastic sheet reaches the chosen temperature of the operator, they slide down thermoform structural supports 16a, 16b, 16c, and 16d via trolley steppers 11a and 11b. Heating element array 10 is controlled via electronics within electronic enclosure 4 and can be controlled via LCD display 10. The present disclosure is not limited with regard to the manner by which a user interacts with the machine. A touchscreen, a graphical user interface (GUI), a keypad, voice recognition commands, and other known user interface strategies are within the scope of the present disclosure.

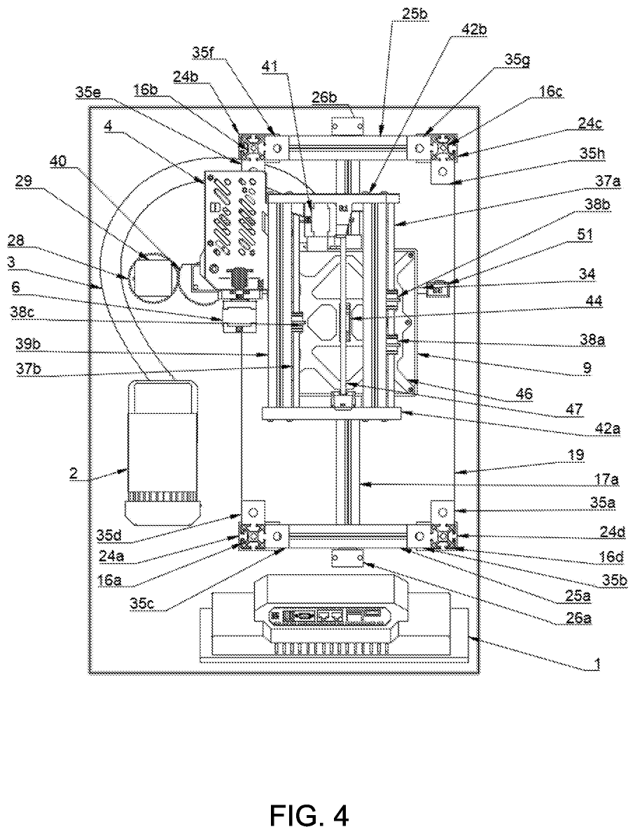

FIG. 4 refers to another view of machine 60. Similar to FIG. 1, FIG. 2, and FIG. 3, several components cannot be seen in FIG. 4 as they are covered by other components. This view of the machine 60 displays user interface 1, vacuum 2, vacuum hose 3, electronics enclosure 4, extruder stepper 6, trolley pulley supports 26a and 26b, horizontal trolley beams 25a and 25b, strut supports 35a, 35b, 35c, 35d, 35e, 35f, 35g, and 35h, thermoform structural supports 16a, 16b, 16c, and 16d, linear slides 24a, 24b, 24c, and 24d, vertical trolley beams 17a and 17b, heating element base plate 19, y-axis braces 42a and 42b, y-axis belt 47, frog plate 46, vacuum print bed 9, linear bearings 38a, 38b, and 38c, y-axis belt attachment 44,y-axis structural supports 39a and 39b, x-axis linear rod 34, x-axis pulley support 51, y-axis linear rod 37a and 37b, driven pinion gear 40, driving pinion gear 28, and pivot stepper support 29.

The movement of the vacuum print bed 9 in the y-axis can be further understand from in FIG. 4. Vacuum print bed 9 is attached to the printer sub assembly via linear bearings 38a, 38b, and 38c, which slide parallel to linear rods 37a and 37b. Y-axis stepper 41 powers this movement and translates its rotational movement into linear movement via y-axis belt attachment 44 which attaches the vacuum print bed 9 to the belt attached to y-axis belt attachment 44.

Amongst the structures running in the y direction is also y-axis structural supports 39a and 39b. These components not only serve to give structural support during y-axis movement by vacuum print bed 9, but also are the limiting factor in total distance the vacuum print bed 9 can move, along with y-axis linear rods 37a and 37b. If these components were made longer, the machine's movement can become greater and therefore make for an increasingly larger machine with ease.

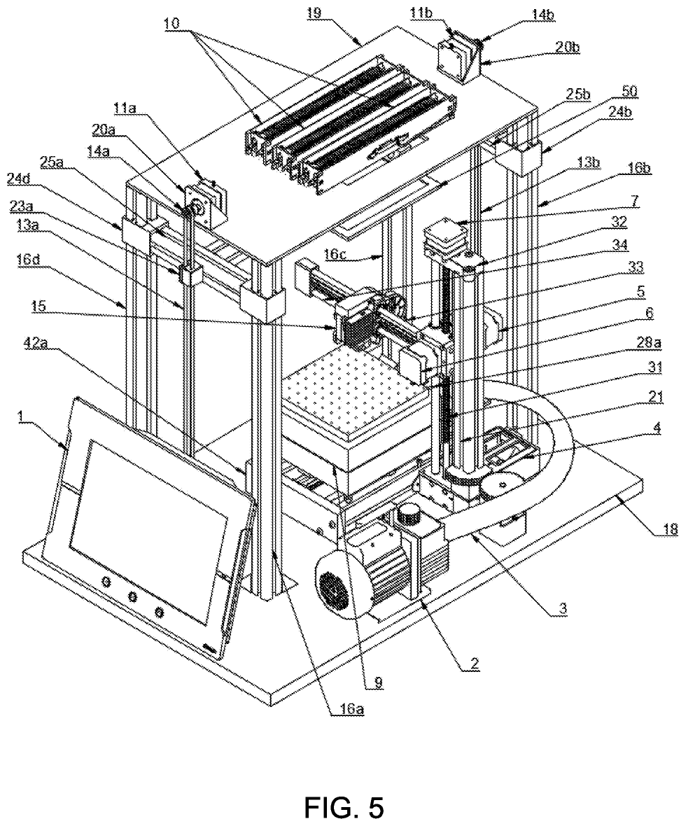

FIG. 5 refers to an isometric view of machine 60. While some components are still hidden in this view, it more clearly displays user interface 1, vacuum 2, vacuum hose 3, electronics enclosure 4, x-axis stepper 5, extruder stepper 6, z-axis stepper 7, thermoform supports 16a, 16b, 16c, and 16d, vacuum print bed 9, base plate 18, z-axis strut 21, lead screw 31, z-axis linear rod 28a, x-axis linear rods 33 and 34, z-axis stepper support 32, trolley belts 13a and 13b, linear slides 24a, 24b, 24c, and 24d, horizontal trolley beam 25a and 25b, trolley steppers Ila and 11b, trolley stepper holders 20a and 20b, trolley pulleys 14a and 14b, heating element base 19, heating element array 10, trolley belt attachment 23a, hot end 15, and y-axis brace 42a.

Z-axis stepper 6 moves parts 33, 15, 34, and more along the z-axis. Unlike the Y-axis and x-axis which move via stepper motors with belts, z-axis stepper moves the arm with hot end 15 via a lead screw which is within stepper 6 itself. The threads on the lead screw, which is part of stepper 6, rotate and mesh with matching threads on the arm with hot end 15 and move along the z-axis. While the machine is printing a part this z-axis system remains stationary. However, once printing has finished the arm with hot end 15 pivots away from the print bed in a counterclockwise direction. By pivoting said arm, space is then made for thermoplastic holder 50 and the sub assembly that moves it, to slide directly down, as discussed earlier, and slide down over vacuum print bed 9 without any contact of other parts.

Following thermoplastic holder 50 sliding over vacuum print bed 9, vacuum 2 is turned on and removes air from within vacuum print bed 9. Since this happens while thermoplastic holder 50 is down an airtight seal is created removing air from around the recently printed part and thermoplastic within thermoplastic holder 50, pulling the hot thermoplastic sheet tightly across the additively manufactured part. The array of holes on vacuum print bed 9 provide a way for the air between the top surface of print bed 9 and thermoplastic sheet in thermoplastic holder 9 to be evacuated quickly and efficiently. It will be recalled that as an alternative to removal of air with a vacuum positive air pressure could be used.

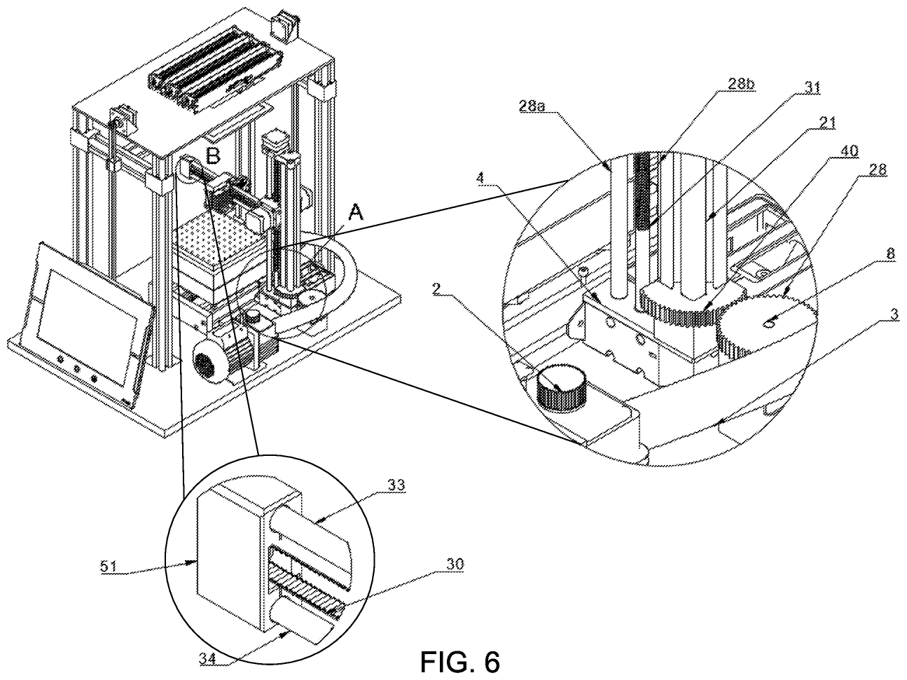

FIG. 6 displays detailed views A and B. Where detailed view B shows a clearer view of parts at the end of the x-axis assembly and detailed view shows a cleared view of gears involved in the pivoting function of the machine. Detailed view A displays vacuum 2, vacuum hose 3, electronics enclosure 4, pivot stepper 8, driving pinion gear 28, driven pinion gear 40, z-axis strut 21, lead screw 31, z-axis linear rod 28a, and z-axis strut 21. Detailed view B displays x-axis linear rods 33 and 34, x-axis belt 30, and x axis pulley support 51.

Detailed view A shows how the pivot action discussed earlier occurs. Once again a stepper motor is used where two pinion gears mate with one another. One on the z-axis strut 21, referred to as driven pinion gear 40, the other attached to pivot stepper 8, and referred to as driving pinion gear 28. As driving pinion gear turns clockwise with pivot stepper 8, driven pinion gear 40 meshes with it and turns the assembly its attached to, therefore rotating the z-axis away from the print bed. In another implementation a pivot stepper or other suitable motor in any arrangement and/or using any number of gears, including no gears, could be used to directly drive the assembly.

Detailed view B gives a clearer differentiation between parts on the x-axis. Similar to the movement in the y-axis a stepper motor, belt, and linear rods are used. Linear rods 33 and 34 are the bodies which hot end 15 slides along while, x-axis belt 30 provides the physical movement as it is looped around x-axis stepper 6. Part 51 acts as a housing for the end of linear rods 33 and 34 as well as a place for x-axis belt 30 to make a rotation around.

### INDUSTRIAL APPLICABILITY

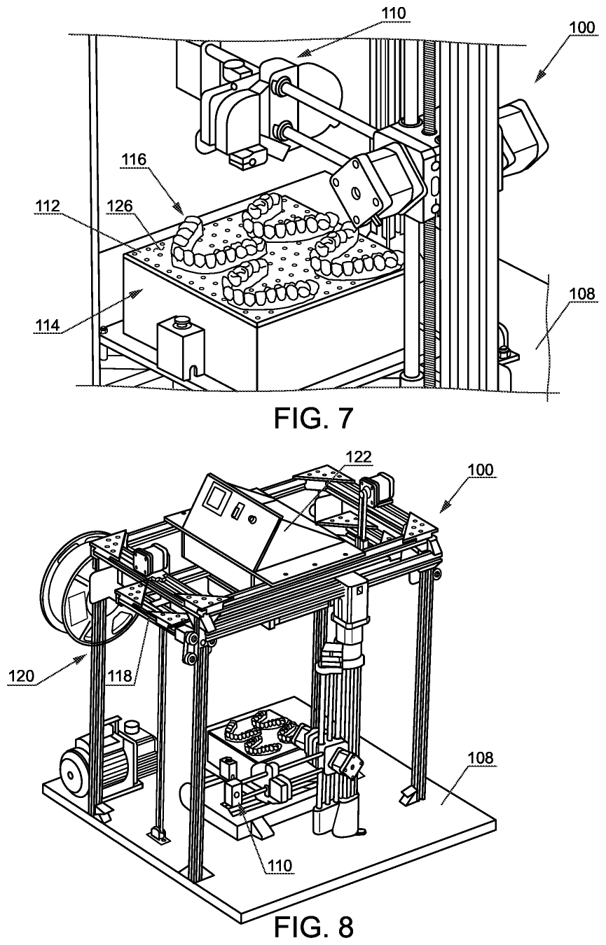

Referring to the drawings generally, now focusing on FIG.7-10, there shown stages in making one or more parts 116 using a machine 100 according to the present disclosure. The machine 100 may be similar or identical to other machines discussed herein, and includes a print head 110 that can be pivoted about a vertical axis above a heated bed 112. Heated bed 112 includes a print surface 126 that is perforated, and may be supported upon a support stand or the like 114. Machine 100 includes similar or identical components to those discussed elsewhere herein supported upon and vertically above a base 108. A carriage 120 is operable to move a tray 118 vertically between a heating array 122 and heated bed 112 to position thermoplastic material or sheets supported in tray 118 over parts 116 for thermoforming.

In FIG. 7, machine 100 is depicted as it might appear where parts 116 have been printed using print head 110. In the illustrated embodiment, parts 116 include arches as might be used to create molds for straightening or otherwise adjusting teeth in a human individual. Parts 116 can be used as a negative image of molds to be used for production of alignment devices that form an end user product. Principles discussed herein connection with producing parts 116 are applicable without regard to the specific type of part being made.

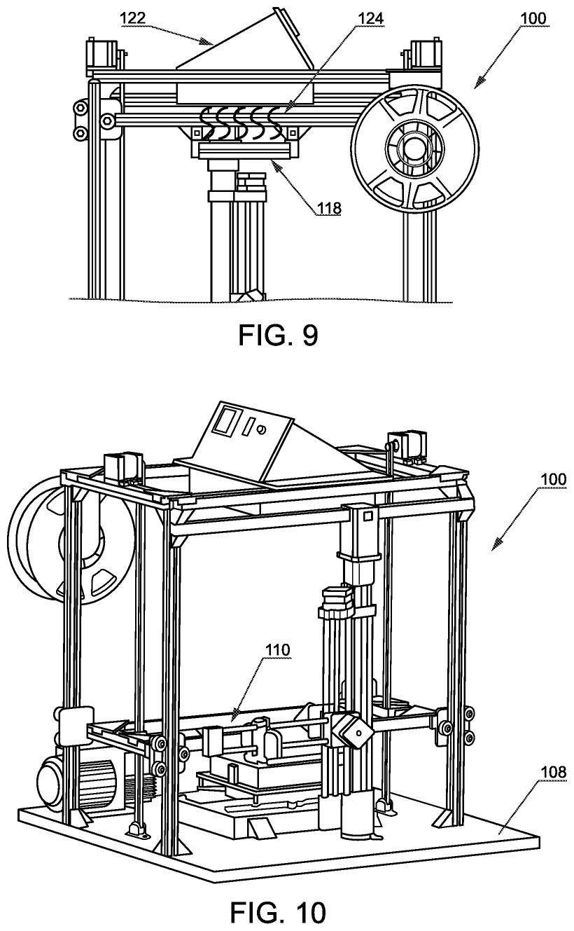

At FIG. 8, print head 110 has been pivoted out of the way in preparation for thermoforming. Heated bed 112 has been heated and heating array 122 is heated to increase a temperature of a thermoplastic sheet loaded in tray 118 by way of radiant heat 124 depicted in FIG. 9. When the thermoplastic sheet has been heated to a desired temperature, carriage 120 is operated to lower tray 118 and position the thermoplastic sheet upon parts 116. FIG. 10 approximately depicts this stage in the procedure. Vacuum can then be applied to draw air through perforations in print surface 126 and the sheet suctioned down onto parts 116 for removal of air and completion of the process. Carriage 120 can then be operated in reverse to raise tray 118 for loading of a new thermoplastic sheet and printing of a new part or parts.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended. claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based. at least in part, on” unless explicitly stated otherwise.

What is claimed is:

1. A machine for combined additive manufacturing and thermoforming comprising:
a bed including a print surface;
a print head supported at a location vertically about the print surface, and pivotable between a stowed position and a range of printing positions;
a thermoforming subassembly including a heating array and a sheet tray;
the thermoforming subassembly being movable between a first position, and a second position in proximity to the print surface to position a heated thermoforming sheet for attachment to a part upon the print surface.

2. The machine of claim 1 further comprising an actuator operable to adjust the sheet tray between the first position and the second position.

3. The machine of claim 2 wherein the first position includes a raised position, and the second position includes a lowered position.

4. The machine of claim 1 wherein the print surface includes a perforated surface.

5. The machine of claim 1 further comprising a trolley subassembly operable to move the sheet tray between the first position and the second position.

6. The machine of claim 1 wherein the heating array includes heaters supported at a fixed position vertically above the bed. 7 A method of making a part comprising:
additively forming a part upon a print surface by way of a print head;
moving the print head from a printing location to a stowed position;
positioning a heated thermoforming sheet in proximity to the additively formed part;
attaching the thermoforming sheet to the additively formed part while upon the print surface.

8. The method of claim 7 wherein the attaching the thermoforming sheet includes attaching the thermoforming sheet by way of a negative pressure or a positive pressure of air.

9. The method of claim 8 further comprising heating the print surface.

10. The method of claim 7 wherein the positioning a thermoforming sheet includes lowering the thermoforming sheet from a raised position vertically above the print surface, to a lowered position in proximity to the additively formed part.

11. The method of claim 10 further comprising operating a trolley subassembly to perform the positioning of the thermoforming sheet.

12. The method of claim 7 wherein the part is one of a plurality of parts coupled together by way of the thermoforming sheet.

13. The method of claim 12 wherein the plurality of parts includes a plurality of negative image molds.

14. A manufacturing station comprising:
a base;
a bed supported on the base and including a print surface;
an air pressure application device structured to apply a positive pressure or a negative pressure of air to a thermoforming sheet upon one or more additively manufactured parts upon the print surface;
a print head pivotable relative to the bed;
a sheet tray for holding a thermoforming sheet at a location raised above the heated bed; and
an actuator for moving the sheet tray to contact the thermoforming sheet to one or more additively manufactured parts upon the bed.

15. The station of claim 14 wherein the actuator is motorized.

16. The station of claim 14 wherein the actuator includes a trolley subassembly having belt drives for raising and lowering the sheet tray.

17. The station of claim 14 wherein the actuator includes an electric motor.

18. The station of claim 14 further comprising a heater array supported at a fixed location vertically above the bed.
